(19) United States
(12) Patent Application Publication
(10) Pub. No.: US 2003/0168440 A1
(43) Pub. Date: Sep. 11, 2003

(54) Lightwave oven with pivotable lamp reflector

(76) Inventors: Martina Backer, Traunreut (DE); Wolfgang Fuchs, Altenmarkt A.D.Alz (DE); Bernhard Herold, Regensburg (DE); Katrin Horn, Traunreut (DE); Kurt Lintner, Nussdorf (DE); Andreas Nitschke, Tacherting (DE); Martin Schulte, Hagen (DE); Martin Thaler, Oberteisendorf (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/354,781

(22) Filed: Jan. 30, 2003

(30) Foreign Application Priority Data
Jan. 30, 2002 (DE) 102 03 609.8

(51) Int. Cl. F27D 11/00

(52) U.S. Cl. 219/405; 219/411

(57) ABSTRACT

A lightwave oven includes a cooking chamber and at least one lightwave heating device that can be moved to and fro on a travel path between a first position and a second position. To distribute the lightwave energy emitted by the lightwave heating device as uniformly as possible in the entire lightwave oven, the lamp reflector is pivotally disposed in the lightwave oven, which achieves an improvement in the browning of edges of food to be cooked.

### BACKGROUND OF THE INVENTION

### Field of the Invention

The invention relates to a lightwave oven having a cooking chamber and at least one lightwave heating device that can be moved to and fro on a travel path between a first position and a second position to heat food in the cooking chamber, and at least one lamp reflector to reflect and/or focus the lightwaves produced by the lightwave heating device in the direction of the food.

Lightwave ovens are ovens that heat the food by visible and infrared radiation. As a result of the action of visible, virtually visible and infrared radiation of high intensity on the food, a very rapid and high-quality cooking and baking method is provided. The cooking times lie approximately in the time frame that is known from the use of microwave ovens, browning being achieved as is known from conventional ovens.

A lightwave oven of the generic type is known, for example, from International publication WO 00/40912 A1, corresponding to U.S. Pat. No. 6,417,494 to Westerberg et al. In this prior art lightwave oven, an upper translucent top wall and a lower translucent bottom wall bound the cooking chamber. Above the translucent top wall, an upper lightwave heating device is disposed such that it can be moved to and fro in an upper duct separated from the cooking chamber. Underneath the translucent bottom wall, a lower lightwave heating device is disposed such that it can be moved to and fro in a lower duct separated from the cooking chamber. In the known lightwave ovens, the light/radiation sources used are tungsten quartz halogen lamps, such as quartz arc lamps.

Due to the construction of a movable lightwave heating device, which can be moved from a first position into a second position and back again, there is the disadvantage that, firstly, the travel speed does not remain constant and, therefore, the lightwave energy emitted by the moved lightwave heating device is not distributed uniformly to the food and, secondly, because of the size of the lightwave heating device and the compactness of the lightwave oven, the edge region cannot be irradiated completely. As a result of these disadvantages, the food is insufficiently or not uniformly cooked or browned, in particular, in the edge region of the lightwave oven.

### SUMMARY OF THE INVENTION

It is accordingly an object of the invention to provide a lightwave oven with pivotable lamp reflector that overcomes the hereinafore-mentioned disadvantages of the heretofore-known devices of this general type and that improves lightwave ovens to the effect that the lightwave energy emitted by the lightwave heating device can be distributed as uniformly as possible in the entire lightwave oven.

With the foregoing and other objects in view, there is provided, in accordance with the invention, a lightwave oven, including a cooking chamber for receiving food therein and at least one lightwave heating device movably disposed in the cooking chamber to and fro along a travel path between a first position and a second position to heat the food in the cooking chamber, the at least one lightwave heating device producing lightwaves and having at least one lamp reflector at least one of reflecting and focusing the lightwaves in a direction of the food, the at least one lamp reflector being pivotally disposed in the cooking chamber.

With the objects of the invention in view, there is also provided a lightwave oven, including a cooking chamber for receiving food therein and at least one lightwave heating device movably disposed in the cooking chamber to and fro along a travel path between a first position and a second position to heat the food in the cooking chamber, the at least one lightwave heating device producing lightwaves and having at least one pivoting lamp reflector at least one of reflecting and focusing the lightwaves in a direction of the food.

According to the invention, at least one lamp reflector is disposed pivotally in the lightwave oven.

Because of the ability of the lamp reflector to pivot, the distribution of the lightwave energy emitted by the radiant lamp in the lightwave oven is influenced not only by the to-and-fro movement of the radiant lamp but also by the pivoting of the lamp reflector.

For example, it has been shown that in the case of foods that assume approximately the entire cooking space, in particular, in the direction of movement of the radiant lamps, the edges of the food are browned less intensely than the central region of the food. The reason for such browning is, firstly, that the lightwaves emitted are focused onto the surface of the food at a focus, in order to achieve good browning, and, secondly, the fact that, because of the spatial extent of the radiant lamps in the oven, the focus of the lightwaves cannot radiate quite to the edge of the cooking chamber. For these reasons, the food is browned less intensely in the edge region. A certain improvement in the edge browning can be achieved if the radiant lamps are moved more slowly in the vicinity of the turning position of the travel path, that is to say, at the edge of the cooking chamber, or even stop for a certain time in the turning positions, as a result of which, an increased quantity of light energy is transferred to the food. However, with respect to uniform browning, no satisfactory results can yet be obtained.

Because of the ability of the lamp reflector to pivot, the focus of the emitted lightwaves can be displaced in the direction of travel or counter to the direction of travel of the lightwave heating device. The lamp reflector is, preferably, pivoted in the direction of the cooking wall chamber to be approached.

In general, it is sufficient to pivot only the lamp reflector. The radiant lamp does not necessarily have to be pivoted as well, in particular, if the radiant lamp is disposed at the focus of the lamp reflector. If the lightwave heating device used is a rod-like or rod-shaped radiant lamp, then the lamp reflector is of channel-like or channel-shaped construction. If the lamp reflector is to be pivotable without the radiant lamp, then the pivot axis of the lamp reflector should run through the axis of its focal point, so that the focus of the emitted beam of light is maintained.

If the lamp reflector forms a structural unit together with the radiant lamp, the entire structural unit, that is to say, lamp reflector together with the radiant lamp, can, preferably, be pivoted. If the lamp reflector and the radiant lamp form one structural unit, these are moved to and fro in the lightwave oven together.

In a central section length of the path, the lamp reflector can remain in a basic position in which the optical axis of the beam of light originating from the reflector runs at right angles to the travel path of the lightwave heating device. If the lightwave heating device is disposed on the top of the muffle, and if the to-and-fro movement is carried out in a horizontal plane, the lamp reflector emits the light vertically downward onto the food when in the basic position. The lamp reflector is, preferably, in the basic position in a central sectional length of 70-95% of the overall travel path.

A pivoting device can move the pivotable lamp reflector. The pivoting device can include a gear mechanism that is coupled to the lamp reflector and is driven by a motor, in particular, an electric motor. The pivoting device of the lamp reflector or the structural unit including lamp reflector and radiant lamp can also be actuated by the travel movement of the lightwave heating device. For such a purpose, a lever is disposed on the lamp reflector or on the structural unit including lamp reflector and radiant lamp, and is disposed in the cooking chamber with a stop at the respective end of the travel path. Due to the travel movement in the direction of the end of the travel path at the respective cooking chamber wall, the lever disposed on the lamp reflector or on the structural unit including lamp reflector and radiant lamp is moved against the stop in the cooking chamber, as a result of which, a force is exerted on the lever that pivots the lamp reflector. Following the turning of the travel movement of the lightwave heating device, the lever is moved away from the stop and a spring mechanism coupled to the lever ensures that the lever returns to its starting position when the stop has been left. As a result of the lever returning into the starting position, the lamp reflector or the structural unit including lamp reflector and radiant lamp is pivoted back into the basic position.

In accordance with another feature of the invention, the at least one lamp reflector moves to and fro along the travel path together with the at least one lightwave heating device.

In accordance with a further feature of the invention, there is provided a first pivoting device pivots the at least one lamp reflector from the basic position into a first pivoted position.

In accordance with an added feature of the invention, the cooking chamber has cooking chamber walls and in the first pivoted position of the at least one lamp reflector, the optical axis is pivoted by an angular amount in a direction of one of the cooking chamber walls closest to the first position.

In accordance with an additional feature of the invention, there is provided a second pivoting device pivoting the at least one lamp reflector from the basic position into a second pivoted position.

In accordance with yet another feature of the invention, in the second pivoted position of the at least one lamp reflector, the optical axis is pivoted by an angular amount in a direction of one of the cooking chamber walls closest to the second position.

In accordance with yet a further feature of the invention, the at least one channel-shaped lamp reflector pivots in relation to the rod-shaped radiant lamp.

In accordance with yet an added feature of the invention, the at least one channel-shaped lamp reflector has a focal point and an axis of the focal point and pivots about the axis of the focal point.

In accordance with yet an additional feature of the invention, the at least one channel-shaped lamp reflector pivots together with the rod-shaped radiant lamp.

In accordance with again another feature of the invention, the at least one lamp reflector pivots during the to-and-fro movement of the at least one lightwave heating device along the travel path.

In accordance with again a further feature of the invention, the pivoting device has a motor drive coupled to the at least one lamp reflector.

In accordance with again an added feature of the invention, the pivoting device has a lever coupled to the at least one lamp reflector and a stop fixed in the cooking chamber, and the at least one lamp reflector pivots by moving the lever against the stop. Preferably, the at least one lamp reflector pivots when the lever is moved against the stop.

In accordance with again an additional feature of the invention, there is provided a spring mechanism holding the at least one lamp reflector in the basic position.

In accordance with still another feature of the invention, the rod-shaped radiant lamp is aligned parallel with the at least one channel-shaped lamp reflector.

In accordance with still a further feature of the invention, the at least one channel-shaped lamp reflector has a generatrix being a section selected from a group consisting of a section of an ellipse, a section of a parabola, and a section of a curve lying therebetween.

In accordance with still an added feature of the invention, the at least one channel-shaped lamp reflector has a focal point and an axis of the focal point, the rod-shaped radiant lamp has an axis of symmetry, and the axis of symmetry runs along the axis of the focal point.

In accordance with still an additional feature of the invention, there are provided an upper duct disposed above the cooking chamber and a lower duct disposed below the cooking chamber, the at least one lightwave heating device being at least two lightwave heating devices respectively disposed in each of the upper and lower ducts.

In accordance with a concomitant feature of the invention, the at least one lightwave heating device is switched on and off at predefined time intervals.

Other features that are considered as characteristic for the invention are set forth in the appended claims.

Although the invention is illustrated and described herein as embodied in a lightwave oven with pivotable lamp reflector, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a perspective view from above an oven housing of a lightwave oven according to the invention having a lightwave heating device that can be moved to and fro;

FIG. 2 is a diagrammatic cross-sectional view through the lightwave oven of FIG. 1;

FIG. 3 is diagrammatic cross-sectional view through the lightwave oven of FIG. 1 with a pivotable reflector; and

FIG. 4 is a diagrammatic cross-sectional view of various pivoted positions of the reflector of FIG. 3.

### DESCRIPTION OF THE PREFERRED EMBODIMENTS

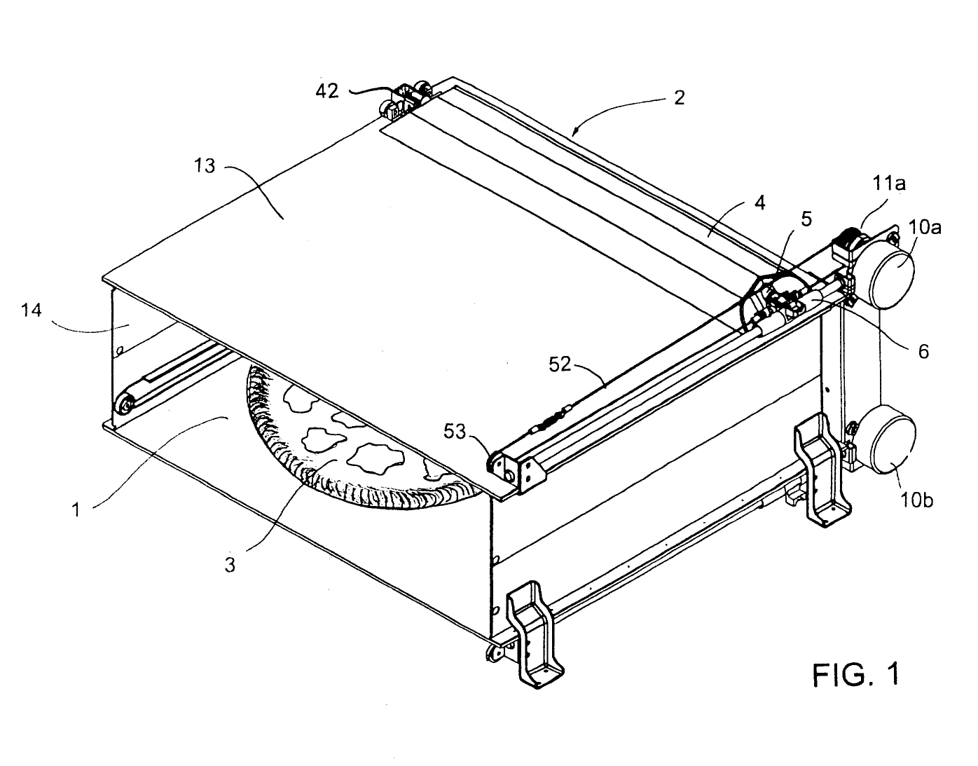

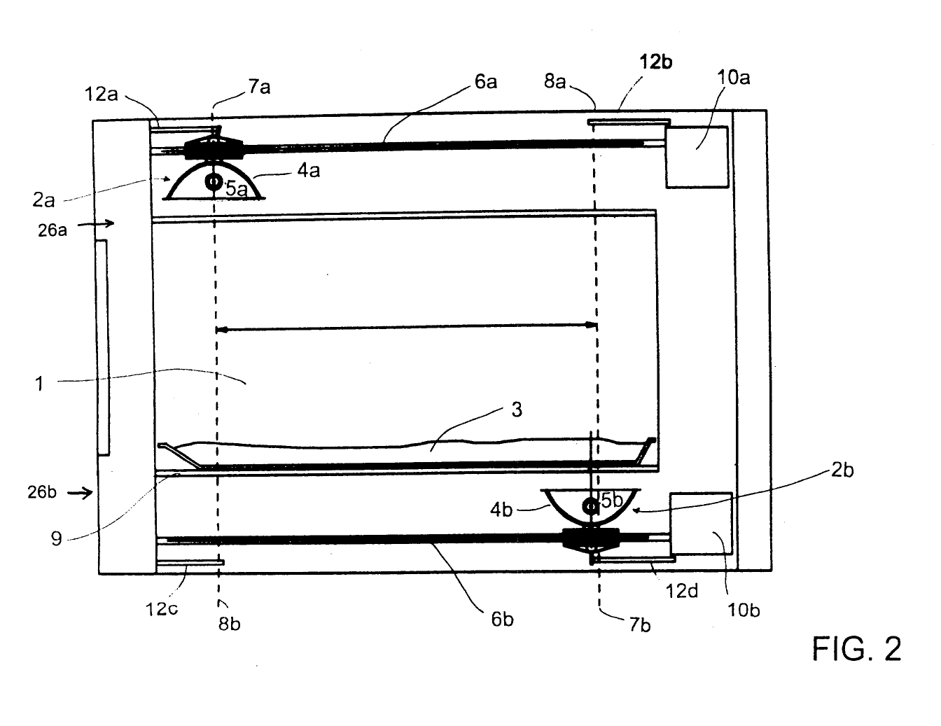

Referring now to the figures of the drawings in detail and first, particularly to FIG. 1 thereof, there is shown a preferred configuration of a lightwave oven having a lightwave heating device that can be moved to and fro. The cooking chamber 1 is enclosed by the oven housing 13 and, on its front side, has an opening 14 for the food 3 to be put into the cooking chamber 1. Above the cooking chamber 1 and underneath the cooking chamber 1 (see FIG. 2), a lightwave heating device 2, 2a that can be moved to and fro is disposed in each case. The lightwave heating device 2a disposed above the cooking chamber 1 includes an upper radiant lamp 5, 5a and an upper lamp reflector 4, 4a. The lightwave heating device 2b disposed underneath the cooking chamber 1 includes a lower radiant lamp 5b and a lower lamp reflector 4b. Each lightwave heating device 2, 2a, 2b is fixed to its own movement device 6, 6a, 6b such that it can be moved to and fro. The upper movement device 6a is driven through a pull cable 52 and a deflection roller 53 and an upper gear mechanism 11a by the stepping motor 10a. The lower movement device 6b is driven in the same way as the upper movement device 6a but independently of the latter by the lower stepping motor 10b.

The schematic cross-section through the lightwave oven, illustrated in FIG. 2, shows the cooking chamber 1 with food 3 placed on the food support 9. The upper lightwave heating device 2a includes the radiant lamp 5a and the lamp reflector 4a. The lower lightwave heating device 2b includes the radiant lamp 5b and the lamp reflector 4b. The upper lightwave heating device 2a can be moved to and fro on a travel path from a first position 7a into a second position 8a by the movement device 6a. The movement device 6a is driven by the stepping motor 10a. The lower lightwave heating device 2b can be moved to and fro on a travel path from a first position 7b into a second position 8b by the movement device 6b. The travel paths of the heating devices 2a, 2b are disposed respectively in ducts 26a, 26b disposed above and below the cooking chamber 1. The movement device 6b is driven by the stepping motor 10b. A limit switch 12a provides a signal to reverse the movement of the upper lightwave heating device 2a in the first position 7a. A limit switch 12b provides a signal to reverse the movement of the upper lightwave heating device 2a in the second position 8a. A limit switch 12c provides a signal to reverse the movement of the lower lightwave heating device 2b in the second position 8b. A limit switch 12d provides a signal to reverse the movement of the lower lightwave heating device 2b in the first position 7b.

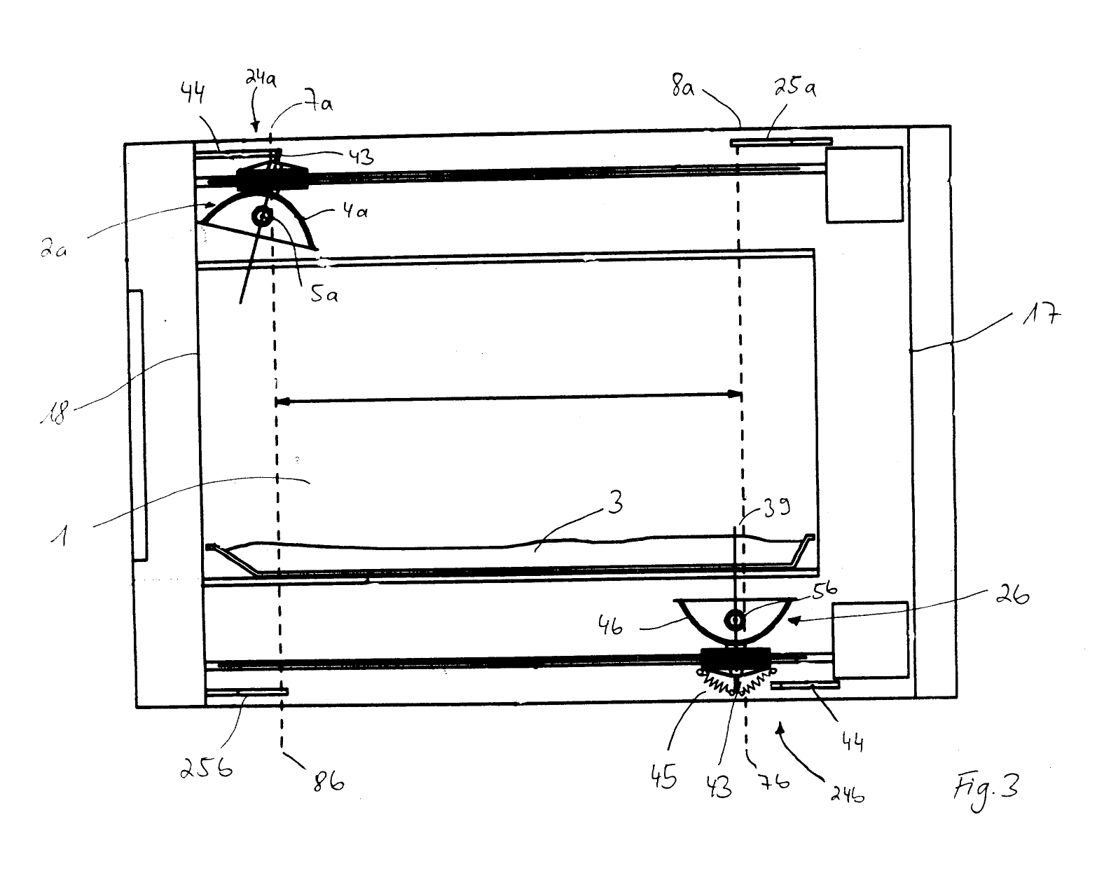

A mechanically pivotable lamp reflector/radiant lamp unit is shown in FIG. 3. The lamp reflector 4a, together with the radiant lamp 5a, forms the pivotable lightwave heating device 2a. This lamp reflector/radiant lamp unit can be pivoted about the axis of the rod-like radiant lamp 5a. Connected to this is a lever 43 that projects upward and that pivots the lightwave heating device 2a. The stop 44 is fixed in the lightwave oven in the vicinity of the front plate 18. As a result of the lightwave heating device 2a moving toward the first position 7a, the lever 43 is pressed against the stop 44 and the lever 43 pivots the lightwave heating device 2a in the direction of the front plate 18.

At the other end of the travel path, the lightwave heating device 2a is pivoted in the same way by the lever 43 moving toward a further stop belonging to the second pivoting device 25a. As a result, the lever 43 pivots the lightwave heating device 2a in the direction of the rear wall 17.

On the lower lightwave heating device 2b, the lamp reflector 4b is illustrated in the basic position 39. The basic position 39 is achieved by a force equilibrium on the lever 43, which is set by a spring mechanism 45 including two tension springs acting at the upper end of the lever 43.

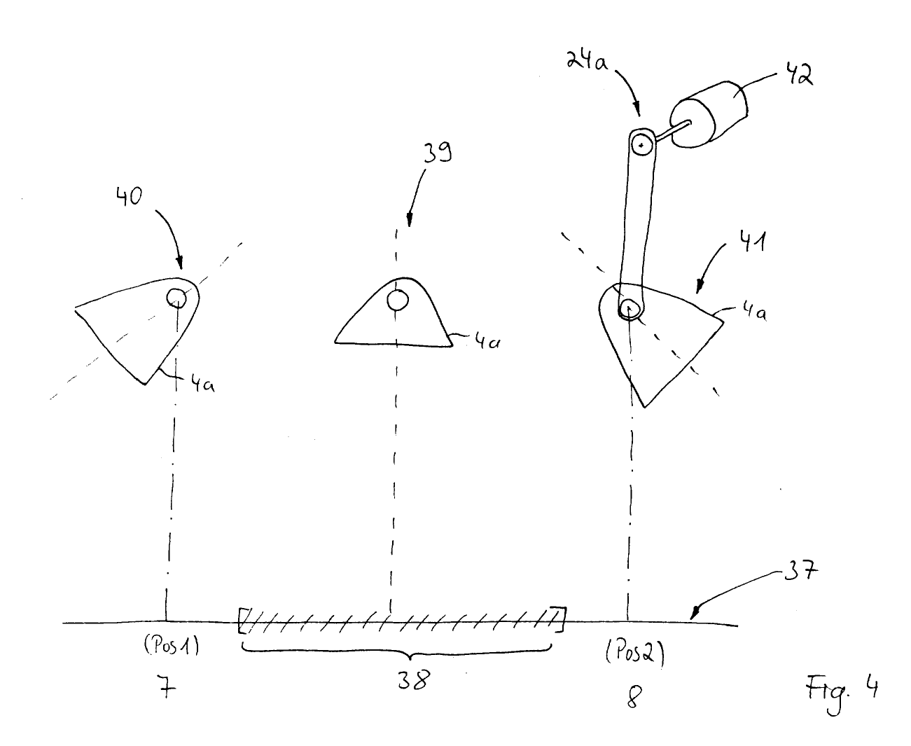

FIG. 4 shows a possible way of driving the pivoting movement of the lamp reflector 4a. In a central section of the path length 38, the lamp reflector 4a is in the basic position 39. In the first position 7, the lamp reflector 4a is pivoted outward into a first pivoted position 40 in the direction of the cooking chamber wall there. In the second position 8, the lamp reflector 4a is pivoted outward into a second pivoted position 41 in the direction of the cooking chamber wall there. The reflector 4a is pivoted by a pivoting device 24a, which is connected to an electric drive motor 42. Preferably, the at least one lightwave heating device (2a, 2b) can be switched on and off at predefined time intervals.

We claim:

1. A lightwave oven, comprising:
a cooking chamber for receiving food therein; and
at least one lightwave heating device movably disposed in said cooking chamber to and fro along a travel path between a first position and a second position to heat the food in said cooking chamber, said at least one lightwave heating device producing lightwaves and having at least one lamp reflector at least one of reflecting and focusing the lightwaves in a direction of the food, said at least one lamp reflector being pivotally disposed in said cooking chamber.

2. The lightwave oven according to claim 1, wherein said at least one lamp reflector moves to and fro along said travel path together with said at least one lightwave heating device.

3. The lightwave oven according to claim 2, wherein:
said travel path has a path length with a central section;
the lightwaves emerges from said at least one lamp reflector in a bundle having an optical axis; and
in said central section, said at least one lamp reflector has a basic position aligning said optical axis substantially at right angles to said travel path.

4. The lightwave oven according to claim 3, wherein said central section of said path length is between approximately 70% and approximately 95% of an entire length of said travel path.

5. The lightwave oven according to claim 3, including a first pivoting device pivoting said at least one lamp reflector from said basic position into a first pivoted position.

6. The lightwave oven according to claim 1, wherein:
said at least one lamp reflector has a basic position aligning said optical axis substantially at right angles to said travel path; and
a first pivoting device pivots said at least one lamp reflector from said basic position into a first pivoted position.

7. The lightwave oven according to claim 6, wherein:
said cooking chamber has cooking chamber walls; and
in said first pivoted position of said at least one lamp reflector, said optical axis is pivoted by an angular amount in a direction of one of said cooking chamber walls closest to said first position.

8. The lightwave oven according to claim 7, including a second pivoting device pivoting said at least one lamp reflector from said basic position into a second pivoted position.

9. The lightwave oven according to claim 8, wherein, in said second pivoted position of said at least one lamp reflector, said optical axis is pivoted by an angular amount in a direction of one of said cooking chamber walls closest to said second position.

10. The lightwave oven according to claim 1, wherein said at least one lightwave heating device has a rod-shaped radiant lamp, said at least one lamp reflector is channel-shaped.

11. The lightwave oven according to claim 10, wherein said at least one channel-shaped lamp reflector pivots in relation to said rod-shaped radiant lamp.

12. The lightwave oven according to claim 11, wherein said at least one channel-shaped lamp reflector has a focal point and an axis of said focal point and pivots about said axis of said focal point.

13. The lightwave oven according to claim 10, wherein said at least one channel-shaped lamp reflector pivots together with said rod-shaped radiant lamp.

14. The lightwave oven according to claim 1, wherein said at least one lamp reflector pivots during the to-and-fro movement of said at least one lightwave heating device along said travel path.

15. The lightwave oven according to claim 5, wherein said pivoting device has a motor drive coupled to said at least one lamp reflector.

16. The lightwave oven according to claim 5, wherein:
said pivoting device has:
a lever coupled to said at least one lamp reflector; and
a stop fixed in said cooking chamber; and
said at least one lamp reflector pivots by moving said lever against said stop.

17. The lightwave oven according to claim 5, wherein:
said pivoting device has:
a lever coupled to said at least one lamp reflector; and
a stop fixed in said cooking chamber; and
said at least one lamp reflector pivots when said lever is moved against said stop.

18. The lightwave oven according to claim 3, including a spring mechanism holding said at least one lamp reflector in said basic position.

19. The lightwave oven according to claim 10, wherein said rod-shaped radiant lamp is aligned parallel with said at least one channel-shaped lamp reflector.

20. The lightwave oven according to claim 19, wherein said at least one channel-shaped lamp reflector has a generatrix being a section selected from a group consisting of a section of an ellipse, a section of a parabola, and a section of a curve lying therebetween.

21. The lightwave oven according to claim 19, wherein:
said at least one channel-shaped lamp reflector has a focal point and an axis of said focal point;
said rod-shaped radiant lamp has an axis of symmetry; and
said axis of symmetry runs along said axis of said focal point.

22. The lightwave oven according to claim 21, wherein said at least one channel-shaped lamp reflector has a generatrix being a section selected from a group consisting of a section of an ellipse, a section of a parabola, and a section of a curve lying therebetween.

23. The lightwave oven according to claim 1, including an upper duct disposed above said cooking chamber and a lower duct disposed below said cooking chamber, said at least one lightwave heating device being at least two lightwave heating devices respectively disposed in each of said upper and lower ducts.

24. The lightwave oven according to claim 1, wherein said at least one lightwave heating device is switched on and off at predefined time intervals.

25. A lightwave oven, comprising:
a cooking chamber for receiving food therein; and
at least one lightwave heating device movably disposed in said cooking chamber to and fro along a travel path between a first position and a second position to heat the food in said cooking chamber, said at least one lightwave heating device producing lightwaves and having at least one pivoting lamp reflector at least one of reflecting and focusing the lightwaves in a direction of the food.
